(19) United States
(12) Patent Application Publication
(10) Pub. No.: US 2002/0072358 A1
(43) Pub. Date: Jun. 13, 2002

(54) Methods and apparatus for real-time performance monitoring in a wireless communication network

(75) Inventors: Ron Schneider, Carlsbad, CA (US); Su-Lin Low, San Diego, CA (US)

Correspondence Address: LYON & LYON LLP, 633 WEST FIFTH STREET, SUITE 4700, LOS ANGELES, CA, 90071, US

(73) Assignee: Telefonaktiebolaget LM Ericsson

(21) Appl. No.: 09/738,911

(22) Filed: Dec. 13, 2000

(51) Int. Cl. H04Q 7/20

(52) U.S. Cl. 455/423; 455/426

(57) ABSTRACT

A network performance monitor that uses open interfaces recently standardized for wireless communication systems to provide unbiased, real-time performance information and data analysis for each open interface. This in turn allows system operators and manufacturers to allocate resources efficiently and to identify and resolve problems associated with network nodes. The network performance monitor includes a monitor for monitoring messages on at least one communication interface of and an analyzer for analyzing the monitored messages and for generating real-time performance data based on the analysis.

### BACKGROUND OF THE INVENTION

1. Field of the Invention

The invention relates generally to wireless communications, and more particularly to a methods and apparatus for real-time performance monitoring in a wireless communication network.

2. Background

Wireless communication network operators have problems obtaining accurate, real-time performance data related to the functioning of their networks. Such performance data is important to the network operators, because they use the data to optimize the allocation of network resources. This optimization can reduce network operating costs and can also be used to identify and troubleshoot network problems, which improves customer service. Because the data is usually not obtained in real-time, however, recognition of such benefits is delayed. The delay between gathering the data and analyzing it can often render the data useless in providing benefits to the network operators.

Real-time performance data is also useful for lab testing. For example, mobile phone users now expect the same reliability with their mobile phones as they do for their landline phones. As a result, network operators and network node manufacturers must thoroughly verify network performance in the lab environment before deployment into the field. Verification is enhanced if performance feedback can be obtained, analyzed, and reported in real-time.

Network operators have problems obtaining real-time performance data because node manufacturers often use proprietary communication interfaces, which requires network operators to buy entire networks from one vendor. Because of the proprietary communication interfaces, collecting performance data for each node requires specialized software, which cannot be ported to other nodes or other networks. Thus, real-time performance data is difficult to obtain, because data from different nodes must be gathered, converted to a common format, and then analyzed.

### SUMMARY OF THE INVENTION

The invention uses open interfaces recently standardized for wireless communication systems to provide unbiased, real-time performance information and data analysis for each open interface. This in turn allows system operators and manufacturers to allocate resources efficiently and to identify and resolve problems associated with network nodes. The invention is used in both live operational networks and during system level laboratory testing.

Therefore, A network performance monitor for monitoring the performance of a wireless communication network is provided that includes a monitor configured to monitor messages on at least one communication interface of at least one node of the wireless communication network and an analyzer configured to analyze the monitored messages and generate real-time performance data based on the analysis.

In one embodiment, the analyzer combines the real-time performance data for a plurality of nodes to generate composite real-time performance data. In another embodiment, the network performance monitor also includes an emulator configured to perform diagnostic testing by inserting predetermined test messages into specified communication interfaces.

A wireless communication network is also provided that is configured to use open communication interfaces and that includes a network performance monitor as described above.

Other aspects, advantages and novel features of the invention will become apparent from the following Detailed Description of Preferred Embodiments, when considered in conjunction with the accompanying drawings.

### BRIEF DESCRIPTION OF THE DRAWINGS

Preferred embodiments of the present inventions taught herein are illustrated by way of example, and not by way of limitation, in the figures of the accompanying drawings, in which similar elements in the different embodiments are referred to by the same reference numbers for ease in illustration, and in which:

FIG. 1 is a diagram illustrating an exemplary wireless communication network.

FIG. 2 is a diagram illustrating one embodiment of a wireless communication network that employs open communications and includes a network performance monitor in accordance with the invention.

FIG. 3 illustrates example data produced by a network performance monitor monitoring an A1 interface within a wireless communication network such as the one illustrated in FIG. 2.

FIG. 4 illustrates example composite network performance data for a wireless communication network such as the one illustrated in FIG. 2.

### DETAILED DESCRIPTION OF THE PREFERRED EMBODIMENTS

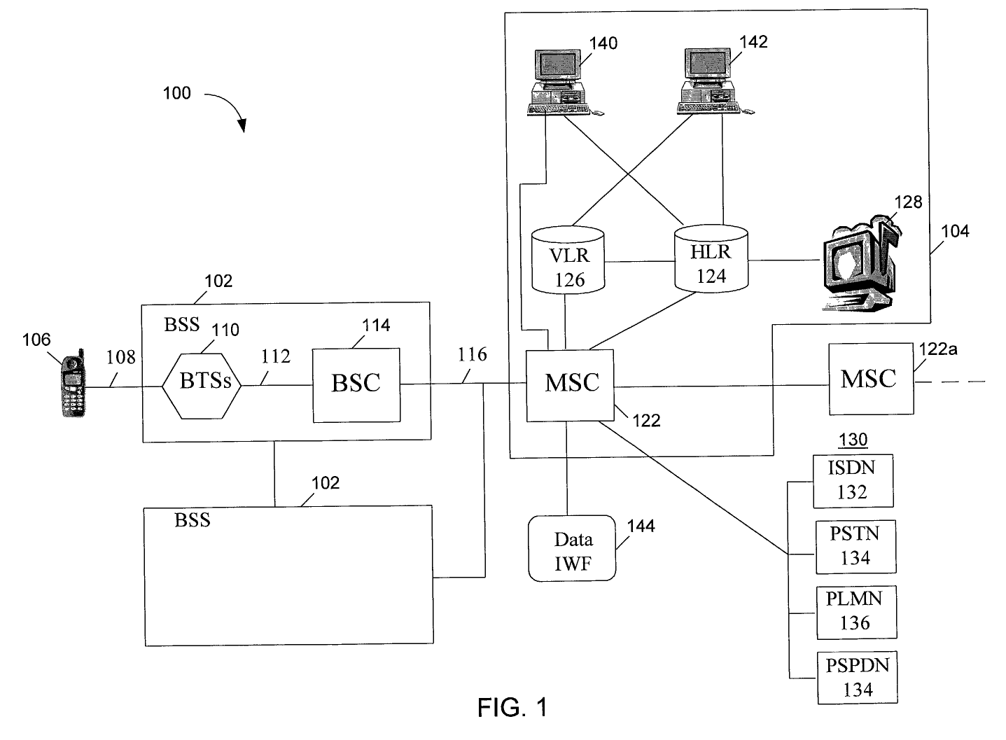

The architecture of one implementation of a cellular network 100 is depicted in block form in FIG. 1. The network 100 is divided into four interconnected components or subsystems:

a Mobile Station (MS) 106, a Base Station Subsystem (BSS) 102, and a Network Switching Subsystem (NSS) 104. Generally, MS 106 is the mobile equipment or phone carried by the user.

And a base station subsystem interfaces with multiple mobiles to manage the radio transmission paths between the mobiles and network subsystem. In turn, the network subsystem manages system-switching functions and facilitates communications with other networks such as the PSTN and the ISDN. The operator support system facilitates operation and maintenance of the network.

A MS 106 is typically a hand-held device used for voice communication. But more and more mobile devices combine voice communication with other applications such as, for example, those typically found in a PDA. In fact, some PDAs and portable computers include wireless transcribers so that the devices can communicate voice and data within a network 100. Therefore, MS 106 can be any device capable of communicating with BSSs 102 within network 100.

MSs 106 communicate with BSS 102 across a standardized radio air interface 108, the “Um” interface. BSS 102 is comprised of multiple base transceiver stations (BTS) 110 and a base station controller (BSC) 114. A BTS 110 is usually in the center of a cell and consists of one or more radio transceivers with an antenna. It establishes radio links and handles radio communications over the air interface with MSs 106 within the cell. The transmitting power of the transceiver defines the size of the cell. Each BSC 114 manages transceivers. The total number of transceivers per a particular controller could be in the hundreds. The transceiver-controller communication is over the “Abis” interface 112. BSC 114 allocates and manages radio channels and controls hand overs of calls between its transceivers.

BSC 114, in turn, communicate with NSS 104 over a standardized interface 116. For example, the interface may use a standardized Base Station Application Part (BSAP) protocol, which allows use of base stations and switching equipment made by different manufacturers. A Mobile Switching Center (MSC) 122 is the primary component of NSS 104. MSC 122 manages communications between mobile subscribers and between mobile subscribers and public networks 130. Examples of public networks 130 that network 100 may interface with include Integrated Services Digital Network (ISDN) 132, Public Switched Telephone Network (PSTN) 134, Public Land Mobile Network (PLMN) 136, and Packet Switched Public Data Network (PSPDN) 138.

MSC 122 typically will interface with several databases or network resources to manage communication and switching functions. For example, MSC 122 may interface with a Home Location Register (HLR) 124 that contains details on each subscriber residing within the area served by the mobile switching center. There may also be a Visitor Location Register (VLR) 126 that temporarily stores data about roaming subscribers within a coverage area of a particular mobile switching center. An Authentication Center (AC) 128 that contains a list of mobile equipment may also be included. Further, equipment that has been reported as lost or stolen may be stored on a separate list of invalid equipment that allows identification of subscribers attempting to use such equipment. The Authentication Center (AC) 128 may also store authentication and encryption data and parameters that verify a subscriber's identity.

Additionally, MSC 122 interfaces with support systems such as a Short Messaging Service Center (SMSC) 140 and Over-The-Air Function (OTAF) 142. SMSC 140 collects short messages for delivery to particular MSs 106 and formats them as text messages to be sent over the “Um” interface 108 to the MSs 106. OTAF 142 is for coordinating mobile services that can be performed over the air with the MSs 106, such as over-the-air activation of new MSs 106.

Network operators currently use two methods to collect network performance in their wireless communication networks. In one method, performance data is first collected at individual nodes. The data from the individual nodes is then consolidated for further processing. For example, each network 100 will include a Network Operating Center (NOC). Therefore, in this approach, performance data is computed independently by each network node and is later consolidated in the NOC. A different node manufacturer, however, may have designed each network node. Because each node manufacturer may use a different design criteria or standard, the resulting consolidated real-time performance data may not be consistent across the network nodes or from network to network. This may result in conflicting data and/or hamper consolidation of the node data. Importantly, the need to compute the data independently means that the performance data is not generated in real-time.

In the second method currently used for performance data collection, network operators use several isolated monitoring tools for data collection. This approach relies on monitoring tools that are typically designed for low level protocol testing. Although these tools are often used in wireless networks, they are usually designed for general data network testing. As a result, the monitoring tools do not provide all of the data analysis functionality required by wireless communication network providers. Since the data is collected on independent monitoring tools for each node, the data must be formatted and transferred to a separate, proprietary, offline data analysis tool for consolidation.

This method, like the first, is also limited. In order to manage the individual monitoring tools required in this approach, different application drivers are needed to configure and control the remote data collection. For example, special drivers may need to be installed in the NOC in order to control the remote data collection for each individual monitoring tool. Because the monitoring tools are sometimes not designed specifically for monitoring the performance of wireless communication networks, the data interfaces and storage capabilities of the tools may limit the amount of data collected. Again, after the data is collected from the individual monitoring tools, it must be transferred to a separate, proprietary, offline data analysis tool. Such offline tools are highly dependent on the software application used by the tool. If the software changes, the accuracy of the offline analysis may be compromised. Moreover, performance data may be formatted differently depending on the particular performance monitor. Therefore, the consolidated performance data may be inconsistent and/or inaccurate. And, as with the previous method, the consolidated performance data is not obtained in real-time.

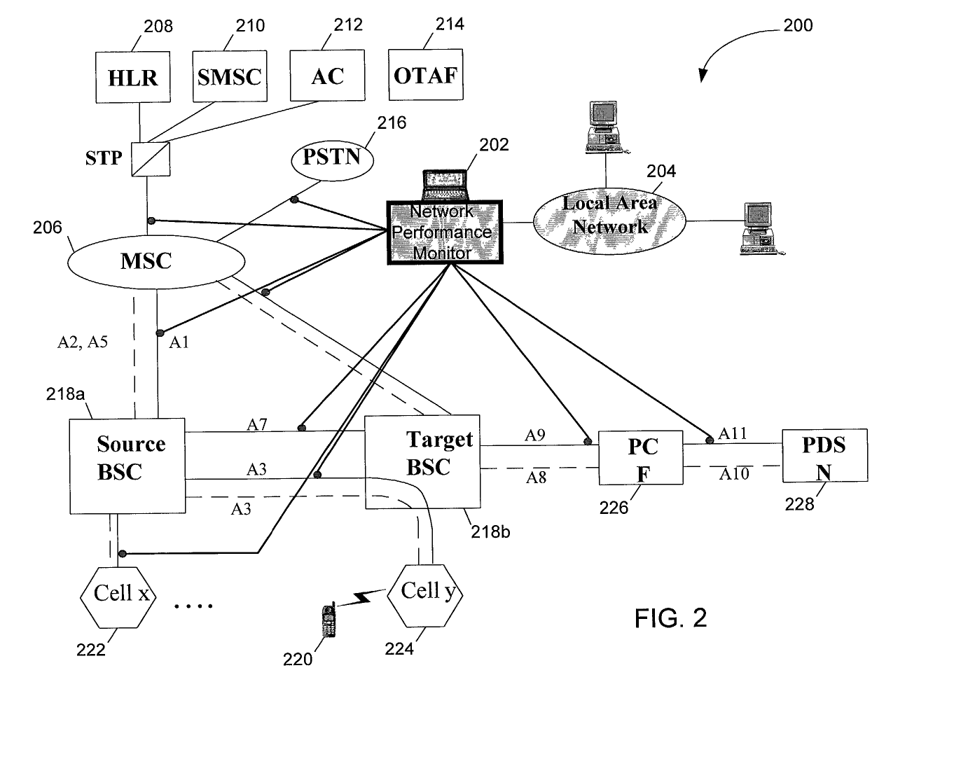

FIG. 2 represents a wireless communication network 200 in accordance with one embodiment of the claimed invention. Importantly, all communication interfaces within network 200 are based on open communication standards and are therefore open communication interfaces. FIG. 2 and most of the description that follows is based on CDMA network architecture. But those skilled in the art will realize that network 200 is not limited to CDMA applications. Rather, the invention is applicable to any network architecture based on standardized open communication interfaces. For example, the invention is equally applicable to GSM, D-AMPS, and TDMA network architectures, assuming they employ open communication interfaces.

In addition to the network subsystems described and discussed in FIG. 1, network 200 includes network performance monitor 202. Network performance monitor 202 typically includes a monitor configured to monitor messages on at least one communication interface in at least one node within the wireless communication network, and an analyzer configured to analyze the messages and generate real-time performance data therefrom. For example, monitor 202 may analyze the following interfaces:

BSC 218 - MSC 206 (A1 interface);

BSC 218a-BSC 218b (A3/A7 interface);

BSC 218 -PCF 226 (A9-interface);

PCF 226 - PDSN 228 (A11 interface);

MSC 206 - HLR 208, SMSC 210, OTAF 214 (ANSI-41-interface);

HLR 208 - AC 212, SMSC 210, OTAF 214 (ANSI-14-interface);

MSC 206 - PSTN 216 (ISUP-interface); and

BSC 218 - BTS 222 (Abis-interface).

BSCs 218 interfaces to MSC 206 over the A1, A2 and A5 communication interfaces. The A1 interface carries parameters associated with CDMA communications as well as parameters associated with network overhead channels. MSC 206 uses the A1 interfaces to supervise message transfers in accordance with the Signaling System 7 (SS7) signaling and BSAP protocols. In addition, MSC 206 interfaces to the various network entities over an ANSI-41 interface. ANSI-41 is a standard developed for internetworking communications within wireless communication networks. Communication between the support subsystems and the network resources is also preferable maintained over ANSI-41 communication interfaces. Thus, for example, HLR 208 communicates with SMSC 210, AC 212, and OTAF 214 over ANSI-41 open communication interfaces. MSC 206 must also interface to the PSTN 216. Preferable, this communication is maintained over a standardized open communication interface. For example, the MSC 206—PSTN 216 interface may use an ISDN User Port (ISUP) protocol. ISUP is defined within the SS7 specification as a communication protocol used to set up, manage, and release trunk circuits that carry voice and data communications over the PSTN.

BSCs, for example BSCs 218a and 218b, communicate over communication interfaces A3 and A7. In a CDMA network, monitoring the A3/A7 interfaces provides information about inter-BSS soft handoffs. A soft handoff occurs when a MS 220 moves from one cell 222 to another cell 224. MS 220 is constantly scanning for and measuring the strength of pilot signals associated with various BSCs. As the pilot in cell 224 becomes stronger, MS 220 will communicate this information to BSC 218a. BSC 218a will then negotiate to hand MS 220 off to BSC 218b. The handoff, however, is seamless as far as the user is concerned. This is as opposed to a hard handoff, where cell 222 drops MS 220, which then re-establishes registration in cell 224. With regard to handoff operations, the BSC handing the MS 220 off is typically referred to as the source BSC, and the BSC receiving the handoff is referred to as the target BSC.

A particular BSC, such as BSC 218b, may also be connected to a Packet Data Serving Node (PDSN) 228 over communication interfaces A8, A9, A10, and A11. Interfaces A8 and A9 interface BSC 218b to a Packet Control Function (PCF) module 226. The PCF 226 controls the exchange of packet data from BSC 218b to PDSN 228. Monitoring the A9/A11 interfaces provide insights into packet data performance information such as packet data session throughput, connect node duration, reactivation counts, dormant and active handoffs, and failure codes or failure reasons.

Additionally, by monitoring the “Abis” interface between BSCs and BTSs, forward and reverse link frame statistics and other related audio information could be obtained for each communication involving MS 220.

It should be noted that in a typical implementation, only the signaling interfaces, i.e., A1, A3 (signaling), A7, A9 and A11 are monitored as opposed to the traffic interfaces A2, A3 (traffic), A5, A8 and A10. This is because the signaling interfaces carry messages that relate to network performance, whereas the traffic interfaces merely carry data from point to point. Therefore, network performance monitor 202 monitors any or all of the open communication interfaces shown in FIG. 2 with the possible exception of the traffic interfaces A2, A3, A5, A8 and A10. The data from the interfaces is merged to provide a composite view of the network's performance. In a particular implementation, a real-time display is used to show information, relating to communications within network 200 and/or network performance statistics. For example, network performance data may be provided for the following performance categories:

Busy hour call rates and call model;

Successful versus failed call attempts, including failure reasons;

Call drops, including failure reasons;

Average call holding times;

Number of successful/failed SMS deliveries;

Individual call traffic statistics;

Summary of packet and circuit data calls statistics;

Number of successful/failed registration attempts;

Identify unusual call activity (such as extremely long call hold times);

Authentication statistics;

SS7 Link utilization statistics;

Trunk utilization statistics; and

Radio forward and reverse link frame error rates.

The A1 interface is particularly useful to monitor messages in relation to call setup, failed call attempts, call clearing, supplementary service performance and hard handoffs. For example, the following messages are available during call setup:

IMSI/MIN/ESN;

Called Party Number;

Slot Cycle Index (slot_cyc);

Cell Identifier (cellid);

Authentication Response, Confirmation, and Count;

Service Option (service_opt);

Voice Privacy Request;

Circuit Identity Code (CIC);

Radio Environment and Resources;

Signal (Alerting Type); and

IS-95 Information Records.

The following message parameters are available during call clearing and are useful for diagnosing the reasons why calls are torn down:

Type of clearing, such as mobile, BSC, or MSC initiated;

Reason for the clearing;

Power down indicator; and

Number of successful vs. abnormal clears.

The following parameters are available to gain visibility into supplementary services performance:

ADDS User Part (SMS or OTASP);

Message length (IS-637 information);

Message Tag value (unique identifier);

Call Identifier; and

Rejection cause value.

The following parameters are available during hard handoffs:

Call Identifier List;

Encryption Information;

IS-95 Channel Identity;

Mobile ESN/IMSI;

Downlink Radio Environment;

Service Option;

CDMA Serving One-Way Delay;

Circuit Identity Code (CIC);

Extended Handoff Direction Parameters; and

Hard Handoff Parameters.

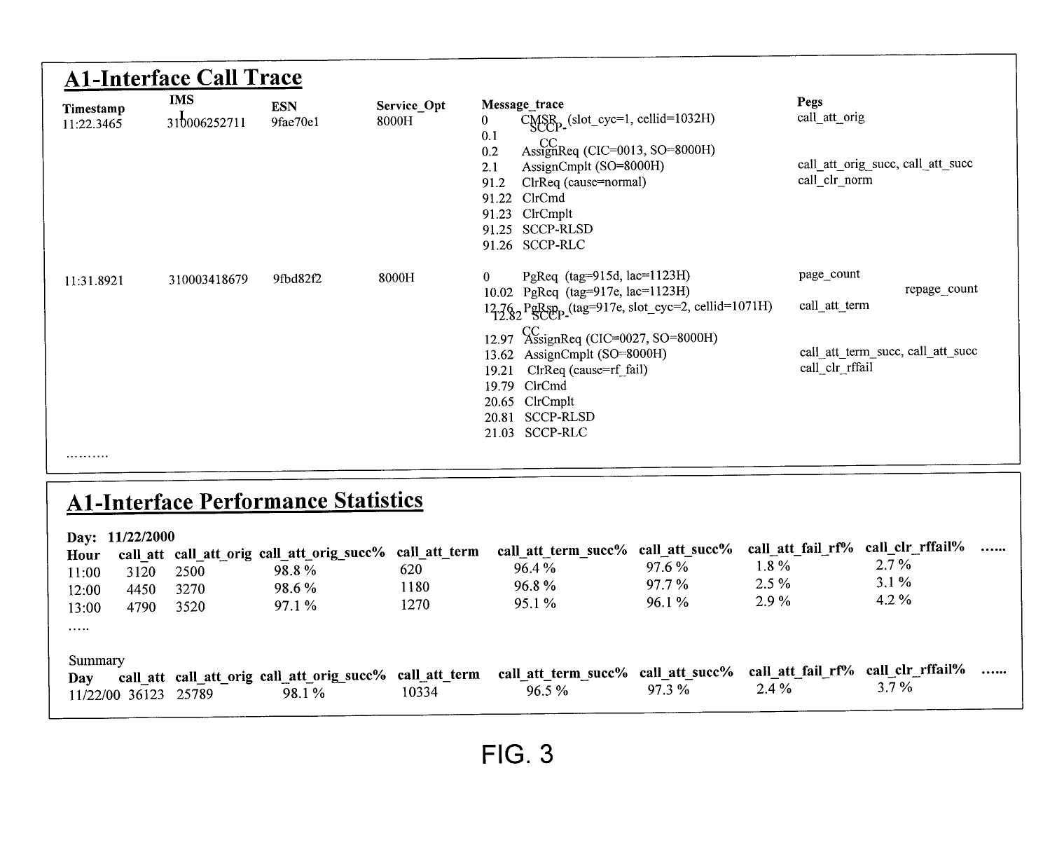

The sample communications trace in FIG. 3 illustrates the real-time operation of the network performance monitor 202 in monitoring and analyzing the A1 interface. The trace includes a time stamp of when the communication began, the International Mobile Subscriber Identifier (IMSI) for the particular MS 220 involved in the communication, the Electronic Serial Number (ESN) of the MS 220, the service option (Service Opt), the message trace, and the result of certain activities in the “pegs” field. The message trace field contains the message communicated over the A1 interface and the time of the message relative to when the communication was initiated. As the messages in the trace are being received, monitor 202 analyzes them and updates, in real-time, the performance data shown in the lower half of FIG. 3. The performance data can be displayed as shown, or it can be converted into a graphical display. Those operating the network use the performance data to monitor the network's performance and spot any problems as they occur anywhere in the network.

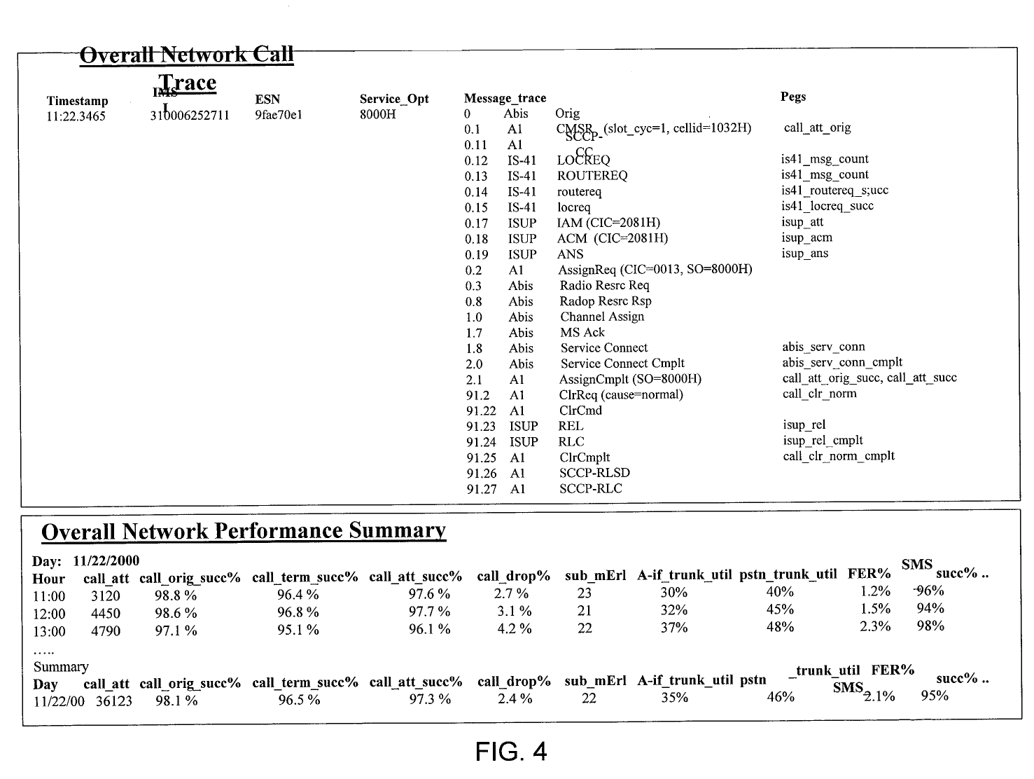

When data from all of the open communication interfaces is combined into composite real-time performance data, the communication trace looks like the one illustrated in FIG. 4. In FIG. 4, the message trace field includes an indicator of the interface the message was received from. The performance data in the lower half of FIG. 4 provides statistics relating to the overall network performance. Therefore, the performance data includes the total number of communication attempts (call_att) the percent of successful communication originations (call_orig.succ %), and the percent of successful communication terminations (call_term_succ %), all of which provides the total percent of successful communications (call_att_succ %). Other statistics are also included, such as the percent of drop calls (call_drop %), the overall Frame Error Rate (FER %), and the percent of successful SMS message deliveries (SMS_succ %).

The real-time performance data can also be shared among many users at the same time. As illustrated in FIG. 2, the network performance monitor 202 may be connected to a Local Area Network (LAN) 204, depending on the implementation. Thus, real-time performance data can be uploaded from monitor 202 to the LAN 204, where multiple remote users can access it. As such, the platform for network performance monitor 202 may be PC or UNIX-based and the network interface (not shown) used to connect network performance monitor 202 to the LAN 204. The network interface may support T1, E1, T3, OC-3, AT or ethernet physical layer protocols. The transport layer protocols supported by the network interface may include SS7, AALs/ATM, MIP, TCP/UDP, GRE, IP, ISUP, ISDN, X25, and Frame relay. Obviously, certain of these transport protocols may be preferred due to the fact that they are used within network 200, although normally this would not impact the performance of monitor 202.

Another advantage of the invention is the ability to troubleshoot, either in the field or in the lab, network 200 using predefined test messages inserted into certain interfaces within network 200. The test messages are designed to generate certain known messages at other interfaces within network 200, which are monitored by performance monitor 202. By analyzing the messages generated by insertion of the test messages into the network, the network's performance can be tested and the data used to isolate faults within network 200. Moreover, such testing can be performed regardless of who manufactured the node or nodes under test.

Those skilled in the art will realize that there can be many variations in the architecture of a wireless communication network. It will be apparent that the invention can be used within any network that utilizes open communication interfaces regardless of the specific architecture employed. As such, the embodiments discussed are by way of example only and do not limit the invention in anyway.

What is claimed:

1. A network performance monitor for monitoring the performance of a wireless communication network, comprising:
a monitor configured to monitor messages on at least one communication interface of at least one node of the wireless communication network; and
an analyzer configured to analyze the monitored messages and generate real-time performance data based on the analysis.

2. The network performance monitor of claim 1, wherein the real-time performance data for a plurality of nodes is combined by the analyzer to generate composite real-time performance data.

3. The network performance monitor of claim 1, wherein the real-time performance data is formatted by the analyzer into statistical percentages indicating the performance level in certain performance categories.

4. The network performance monitor of claim 3, wherein performance categories:
busy hour call rates and call models include at least one of the following; successful versus failed call attempts;
reason for failed call attempts;
call drops;
reason for call drops;
average call holding times;
number of successful and failed SMS deliveries;
reason for failed SMS deliveries;
individual call traffic statistics;
packet data call statistics;
circuit data call statistics;
number of successful and failed registration attempts;
reason for failed registration attempts;
unusual call activity;
authentication;
SS7 link utilization;
trunk utilization; and
radio forward and reverse link frame error rate.

5. The network performance monitor of claim 1, further comprising a display, wherein the network performance monitor is configured to display the real-time performance data.

6. The network performance monitor of claim 1, further comprising a local area network interface, wherein the network performance monitor is configured to transmit the real-time performance data over the local area network interface to a local network.

7. The network performance monitor of claim 1, further comprising an emulator configured to perform diagnostic testing on the wireless communication network by inserting predetermined test messages into specified communication interfaces.

8. A wireless communication network configured to use open communication interfaces, comprising;
a plurality of mobile devices;
at least one network node configured to manage communication between mobile devices and between mobile devices and public networks; and
at least one network performance monitor, the network performance monitor including;
a monitor configured to monitor messages on at least one communication interface of the wireless communication network; and
an analyzer configured to analyze the monitored messages and generate real-time performance data based on the analysis.

9. The wireless communication network of claim 8, wherein there is a plurality of network nodes, and wherein real-time performance data is gathered from the plurality of network nodes and combined by the analyzer into composite real-time performance data.

10. The wireless communication network of claim 8, wherein the network performance monitor further comprises a local area network interface, and wherein the network performance monitor is configured to transmit the real-time performance data to a local area network over the local network interface.

11. The wireless communication network of claim 8, wherein the network performance monitor further comprises an emulator, and wherein the emulator is configured to perform diagnostic testing on the wireless communication network by inserting predetermined test messages into specified communication interfaces.

12. A method of performing diagnostic testing on a wireless communication network, comprising:
inserting predetermined test messages into a first plurality of communication interfaces of the wireless communication network, the test messages designed to generate known messages at a second plurality of communication interfaces;
monitoring messages on the second plurality of communication interfaces; and
analyzing the messages on the second plurality of communication interfaces to determine if they correspond to the known messages.

13. The method of claim 12, further comprising using results from the analyzing step to isolate faults within the wireless communication network.
